(19) United States
(12) Patent Application Publication
(10) Pub. No.: US 2026/0042564 A1
(43) Pub. Date: Feb. 12, 2026

(54) CONTAINER PRODUCED FROM PLASTIC

(71) Applicant: ALPLA WERKE ALWIN LEHNER GMBH & CO. KG, Hard (AT)

(72) Inventors: Oliver UNTERLECHNER, Bregenz (AT); Florian HEIDER, Karlstad (SE); Thomas BOHLE, Alberschwende (AT); Klemens BÖSCH, Lustenau (AT); Christian SCHARINGER, Hard (AT)

(21) Appl. No.: 18/998,545

(22) PCT Filed: Jul. 26, 2023
(86) PCT No.: PCT/EP2023/070720

§ 371 Date: Jan. 27, 2025

(30) Foreign Application Priority Data
Jul. 28, 2022 (CH) CH000914/2022

(51) Int. Cl. B65D 1/02; B29C 49/04; B29K 23/00; B29L 31/00; B65D 1/40; B65D 41/04

(52) U.S. Cl. CPC B65D 1/0246; B65D 1/0207; B65D 1/0292; B65D 1/40; B65D 41/0407; B29C 49/04; B29K 2023/065; B29L 2031/7158; B65D 2501/0081

(57) ABSTRACT

A container being produced from a plastic material, in particular by means of extrusion blow molding, and the container includes a body having a first end and a second end which is substantially opposite the first end, and a casing located therebetween, wherein a bottom having a base is formed at the second end and an opening is formed at the first end, the opening is defined by a neck which surrounds the opening and which is integral with the container, an external thread is formed on the neck, and the screw cap is provided with an internal thread which can interact with the external thread when the screw cap has been put on. The neck is located off-center within the perimeter of the bottom in the top view.

### FIELD OF THE INVENTION

The invention relates to a container that is produced from a plastic material, in particular by extrusion blow molding according to the preamble of the claim, and to a combination of the container with a screw cap according to claim 15.

### PRIOR ART

The production of plastic containers, especially plastic bottles, for example made of polyethylene or polypropylene, takes place in extrusion blow molds. In this case, plastic suitable for blow molding is plasticized and introduced into a tube head by means of an extruder. In the tube head, the plastic is formed into a tube, which is introduced into a blow molding tool. The hose is introduced into the blow molding tool, inflated by overpressure of a gas when the tool is closed so that the hose expands and is pressed against an inner wall of a cavity of the blow molding tool, and assumes the shape of the inner wall, which has a shape that is the negative of a container. The container blown out of the hose is cooled by means of the inner wall until the plastic is hardened. Subsequently, the container is removed from the opened blow molding tool. In a separate step, the so-called slugs, which are formed by the protrusion of the tube during the closing of the blow mold and are generally connected to the removed container, are cut off and can be directed to recycling. The hose can be single-layer or multi-layered.

For pouring the filling material, the container must be cut open or a closure element must be laminated in between the sealing surfaces with a pour opening. If the container is cut open, a pouring opening is produced, which is less user-friendly because an auxiliary means is needed to open it and filling material can easily be spilled during pouring. If a closure element is present, the closure element must be inserted between the sealing surfaces before it can be welded thereto. In addition, the closure element can be produced from a plastic different than that of the container, as a result of which single-type disposal of the container is not possible.

Because these containers are provided in particular for use as refill packaging, improving the decanting of filling material is being pursued in particular. In particular, the resulting uneven flow of the filling material which can build up and inevitably leads to spillage during the decanting process, is not user friendly and is therefore disturbing and annoying for the consumer. This uneven flow is due to the small pouring opening. Air cannot flow into the opening as quickly, and leaves a large amount of space for the filling material. This causes a gush-like outflow of the liquid.

### OBJECT OF THE INVENTION

It is an object of the invention to provide an improved container in which a gush-like outflow of the liquid is reduced or prevented.

### DESCRIPTION

The object is achieved with a container produced from plastic material, in particular by extrusion blow molding according to the preamble of claim 1, by means of the features set out in the characterizing part of claim 1. The dependent claims relate to developments and/or advantageous alternative embodiments.

The container is characterized by the fact that the neck is located off-center within the perimeter of the bottom in a top view. This creates a continuous air connection between the interior of the container and the neck or opening when the filling material is poured out or decanted. A gush-like outflow of filling material, which inevitably leads to spillage of filling material, is prevented by the off-center arrangement of the neck. The user-friendliness of the (refill) container is therefore significantly improved.

It is expedient if the container has a plane of symmetry, and the neck is located off-center in the plane of symmetry. The pouring direction and the gripping position are determined by the plane of symmetry. In addition, the container can be easily demolded owing to the presence of the plane of symmetry.

It is advantageous if the container has a cross-sectional shape such that the user intuitively grips the container by that casing side, to which casing side the distance from the neck is the shortest. In this way, a permanent air connection between the neck and the interior of the container when the filling material or liquid is being poured out is ensured, and the liquid can flow out evenly without gushing.

In a particularly preferred embodiment of the invention, the container has the shape of a cam in cross section. The cam shape makes it possible for the user to intuitively always grasp the semicircular shape of the cam and place their fingers on the semi-ellipse.

The off-center arrangement of the neck is defined by the fact that the cam has a longitudinal axis which lies in the plane of symmetry and a width axis which extends through the greatest width of the cam. This gives the container not only a practical but also an aesthetic shape. The symmetrical shaping preferably also has the effect that the container collapses while the container is being emptied without it drawing in air. To reduce the volume of the container to zero, the container only has to be flattened out at most once again.

It is preferred if the center of the opening coincides with the intersection point of the longitudinal and width axes. This gives the neck an optimum off-center position so that the pouring stream is gush-free. Because the neck is arranged as high up as possible when the container is in the decanting position, the stream can also be more easily directed into the filling opening of the further container.

In a further preferred embodiment of the invention, the container has a wall thickness of 0.2-0.4 mm. This makes the container perfectly suitable as a refill container. The small wall thickness not only saves resources but also allows the container to collapse while being emptied.

It is expedient if a first and a second shoulder adjoin the neck. In this way, the opening can have an optimized shape for the intended use of the refill container, and can transition with a flowing shape into the casing of the container. It is therefore also preferred if the first and second shoulders transition into the casing of the container.

The first shoulder expediently has a convex shape proceeding from the neck. The first shoulder therefore has the shape of an outwardly curved arch, which allows the neck to be positioned far to the outside on the main axis as required by the use of the container.

In a further preferred embodiment of the invention, the second shoulder has a concave shape proceeding from the neck and runs with a convex shape into the casing. The second shoulder can therefore be S-shaped, which allows the neck to be brought closer to the filling opening of the further container and allows an improved flow when pouring.

In a particularly preferred embodiment of the invention, the sealing action between the sealing element and the neck is realized in that the neck is expanded when the sealing element projects into the neck. This type of sealing function makes it possible for the second neck to be designed to be particularly thin-walled, since the necessary stiffness for the production of the seal is provided by the sealing element. This also allows the neck to be formed with little plastic material.

The engagement portion is expediently a depression which acts as the sealing element. As a result, the sealing element fulfills two functions, and the screw cap requires less plastic material for its production given a corresponding design. The invention is preferably characterized in that the opening is defined by a neck surrounding the opening which is formed integrally with the container, and in that an external thread is formed on the neck which can interact with the internal thread of a screw cap. This allows the container to be manufactured particularly quickly and inexpensively. The one-piece design also ensures that the plastic of the container and the plastic forming the opening are identical. These features allow further production steps to be obsolete, and the neck can be disposed together with the container as the same material.

In a particularly preferred embodiment of the invention, the container has no further opening. This means that the blow mold can be produced inexpensively, and price drivers in the form of complicated blow molds are avoided. Here, by contrast to the alternative embodiment having two necks, the welding process on the filling line is eliminated. There is thus no need to install a welding system on the filling line, which results in significant cost savings for the customer.

In a further particularly preferred embodiment, the neck is blow molded together with the container. This means that the entire container is produced in one blow mold, and then merely needs to be filled and closed with the screw cap. No further processing steps are necessary, and the container is produced from a single type of plastic.

The container is preferably produced from HDPE, wherein the proportion of recycled HDPE is between 10 and 100% by weight. This makes the container very good for extrusion blow molding and is environmentally and material-friendly.

A further aspect of the invention relates to a combination of the container described above and a screw cap having an internal thread. This combination is distinguished by the fact that the external thread obtains its final stiffness by way of the screw connection with the screw cap. Since the container is a lightweight container having small wall thicknesses for refilling purposes, this means that the neck having the external thread is also thin-walled and less stable. However, this instability can surprisingly be compensated by tightening the screw cap on the neck. Owing to the thin neck wall and the small thickness of the external thread, the external thread can be compressed along the screw axis by the screw cap. In this way, not only the neck but also the external thread can be formed with less material. The rigidity is achieved through a kind of “accordion effect”, and the opening is reliably sealed.

Further advantages and features become apparent from the following description of a plurality of exemplary embodiments of the invention with reference to the schematic representations. In the figures, in a representation that is not to scale:

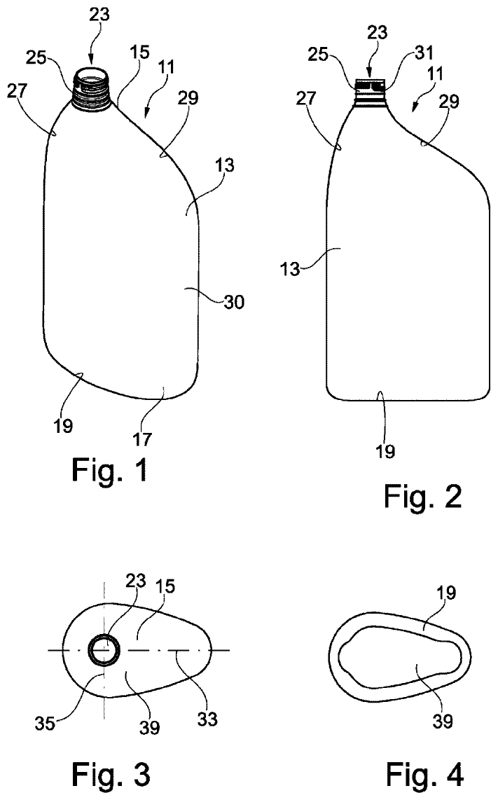

FIG. 1: is a perspective view of an extrusion blow molded container having a neck formed from the container and which surrounds an opening;

FIG. 2: is a side view of the container from FIG. 1;

FIG. 3: is a top view of the container from FIG. 1;

FIG. 4: is a bottom view of the container from FIG. 1;

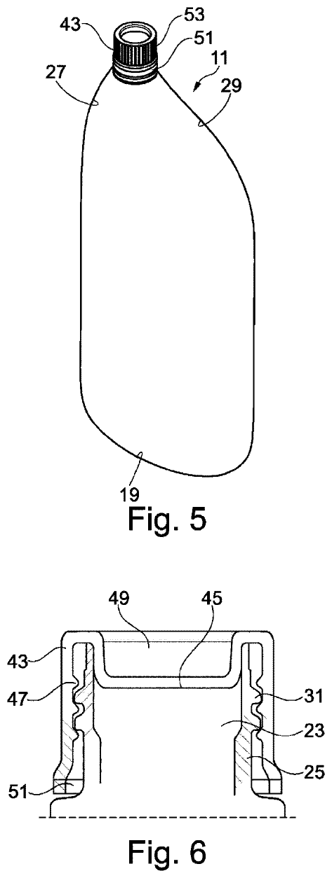

FIG. 5: is the container with a screwed-on cap;

FIG. 6: is a sectional view through the container neck and the screw cap screwed onto the neck; and

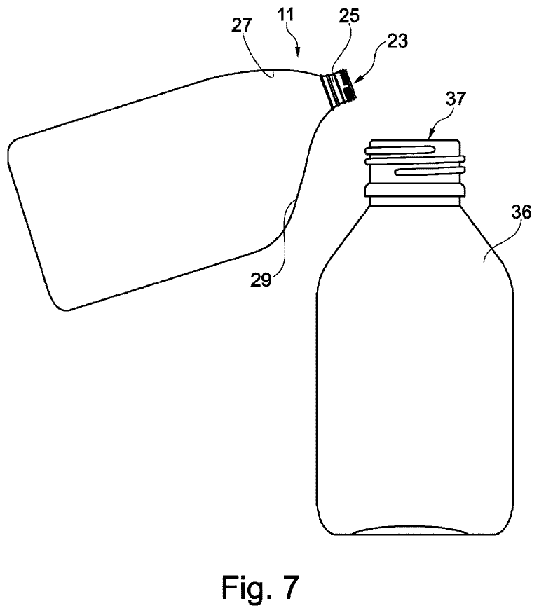

FIG. 7: is a representation of the container during the refilling of a further container with filling material.

FIG. 1 to 5 show a container that is produced from a plastic material by extrusion blow molding and is designated overall by reference sign 11. The container 11 is provided in particular as a so-called “refill container”. This means that it is as lightweight as possible and is stabilized by the filling material when it is full. Nevertheless, it has sufficient inherent stability to permanently maintain its container shape. After the filling material has been completely decanted into an existing container, the refill container 11 can, owing to its relatively low inherent stability and a wall thickness of 0.2 to 0.4 mm, be folded up to such a small size that its filling volume is almost zero. The small wall thickness also means that the refill container collapses during pouring, and merely needs to be folded up slightly after being emptied. This approach is particularly sustainable, in particular if the container is produced partially or even entirely from recycled plastic. The container may be produced from polyethylene or polypropylene and in particular from HDPE.

The container 11 has a body 13 that has a first end 15 and a second end 17 that is substantially opposite the first end 15. The second end 17 is closed fluid-tight and is designed as a bottom 19 on which a base 21 is formed.

At the first end, an opening 23 is blow-molded together with the rest of the container 11 and is therefore formed simultaneously with the container 11 in the blow mold by inflating the container material. The container 11 preferably has no further opening. As a result, the blow mold can be of simple design, the container 11 requires less material for its production, and the opening can be closed by a screw cap 37 after filling.

The opening 23 is defined by a neck 25 which surrounds the opening 23 and which is adjoined by a first and a second shoulder 27, 29. The shoulders 27, 29 transition smoothly into the casing 30 of the container 11.

In a particularly advantageous embodiment, the opening 23 is located within the mold parting and within the perimeter of the bottom 19 (FIG. 3). This ensures that sufficient material is present for forming an external thread 31 on the 25.

FIG. 3 shows that the bottom 19 of the container can have a longitudinal axis 33 and a width axis 35. The opening 23 and the neck 25 are located on the longitudinal axis so that the requirement described in the last paragraph is met.

According to FIG. 3, the opening 23 is arranged off-center on the longitudinal axis 33 in the top view.

The first shoulder 27 runs convexly proceeding from the neck 25, whereas the second shoulder 29 has a concave shape proceeding from the neck and runs with a convex shape into the casing. This feature, together with the off-center arrangement of the opening 23 and the neck 25, is illustrated in FIG. 7. The neck 25 is thus situated in a favorable position to allow filling material to be decanted into a further container 36 without spilling. The S-shape of the second shoulder 29 allows the second shoulder to not be in the way during decanting. In this way, the neck 25 can be brought as close as possible to the filling opening 37 of the further container, and filling material can be poured without spilling. Owing to the off-centered arrangement of the neck 25, there is a continuous air connection from the air space within the container to the opening 23. This reliably prevents a gush-like flow of the filling material out of the opening, in particular if the user pours or refills the further container 36 slowly. The prevention of gushing, colloquially known as glugging, leads to particularly user-friendly refilling of the further container 36.

To bring the container 11 into the correct position when decanting, the user must grip it by that casing side which is situated closest to the opening 23 or the neck 25. This should preferably occur intuitively. This means that the user should grip the container correctly without having to think about it. To meet this requirement, the container 11 has the shape of a cam 39 in cross section. The longitudinal axis 33 of the cam 39 lies in a plane of symmetry 41. The width axis 35 extends through the greatest width of the cam 39. The center of the opening 23 and the intersection point of the two axes 33, 35 coincide. By definition, the cam possesses the shape of a semicircle on one side of the width axis 35 and the shape of a semiellipse on the other side of the width axis. Since the container is easier to grip by the semicircle and less likely to slip away from the user, the user will always grip the container by this side. This means that during decanting, the neck is always in the correct position which prevents gushing of the filling material that is to be decanted.

The external thread 31 has been developed specifically for the use of lightweight packagings, in particular refill containers. Said external thread can be formed with very little material and only obtains its final stiffness by the screw connection with the screw cap 43 because said external thread is compressed by the attached screw cap 43.

The screw cap 43 has a sealing element 45 and an internal thread 47 formed thereon which projects into the opening 23 when the screw cap has been placed on the neck 25. The internal thread 41 interacts with the external thread 31. The sealing element 45 is designed to be rigid in such a way that it can expand the thin-walled neck 25. This results in the sealing action between the neck 25 and the screw cap 43.

The screw cap 37 preferably has a depression 49 which acts as the sealing element 45. The depression may have an engagement portion for a tool in order allow a torque to be transmitted to the screw cap 43 in a form-fitting manner. The engagement portion may be a hexagonal socket or some other polygon.

The screw cap may also have a security ring 51 as shown in FIGS. 5 and 6. The neck 25 also provides a height sufficient to enable a retaining band to be provided on the security ring 51. After unscrewing, the retaining band holds the unscrewed threaded part 53 captively on the security ring 51 or on the neck 25.

The extrusion blow molded container 11 is formed in one piece, and the neck 25 is blow molded together with the container body 13 in one mold. The neck is therefore an integral part of the container 11 and does not need to be subsequently inserted therein and connected thereto. The container 11 is distinguished by the fact that it allows the filling material to be poured out without gushing due to the off-center arrangement of the neck 25. The cam-shaped cross section ensures that the user always uses or grips the container 11 in such a way that it maintains the correct position relative to the further container 36 during decanting.

In addition, the container 11 is lightweight and thin-walled and nevertheless has a sufficiently stable and accordingly sealed screw cap. The stability is created by tightening the screw cap 43 on the neck 25 because this causes the external thread 31 to be compressed along the longitudinal axis and stabilized, and the thin-walled neck 25, which can be expanded at its open end by the sealing element 45.

### LIST OF REFERENCE SIGNS

11 Container
13 Body of the container
15 First end
17 Second end
19 Bottom
21 Base
23 Opening
25 Neck
27 First shoulder
29 Second shoulder
30 Casing
31 External thread
33 Longitudinal axis
35 Width axis
36 Further container
37 Filling opening
39 Cam
41 Plane of symmetry
43 Screw cap
45 Sealing element
47 Internal thread
49 Depression
51 Security ring
53 Threaded part

1.-15. (canceled)

16. A container produced from a plastic material, in particular by extrusion blow molding, comprising:
a body having a first end and a second end which is substantially opposite the first end, and a casing located therebetween,
a bottom formed at the second end and having a base,
an opening formed at the first end,
a neck surrounding and defining the opening, which neck is integral with the container, and
an external thread formed on the neck,
wherein a screw cap is provided with an internal thread which can interact with the external thread when the screw cap has been put on,
wherein
the neck is located off-center within the perimeter of the bottom in the top view.

17. The container according to claim 16, wherein the container has a plane of symmetry, and the neck is located off-center in the plane of symmetry.

18. The container according to claim 16, wherein the container has a cross-sectional shape such that the user intuitively grips the container by that casing side, which casing side is at the shortest distance from the neck.

19. The container according to claim 18, wherein the container has the shape of a cam in cross section.

20. The container according to claim 19, wherein the cam has a longitudinal axis which lies in the plane of symmetry and has a width axis which extends through the greatest width of the cam.

21. The container according to claim 20, wherein the center of the opening coincides with the intersection point of the longitudinal and width axes.

22. The container according to claim 16, wherein the container has a wall thickness of 0.2-0.4 mm.

23. The container according to claim 16, wherein the container serves for refilling a further container with filling material, collapses as the filling material is decanted into the further container, and can be folded to a filling volume close to zero after being emptied.

24. The container according to claim 16, wherein a first and a second shoulder adjoin the neck.

25. The container according to claim 24, wherein the first and second shoulders transition into the casing of the container.

26. The container according to claim 24, wherein the first shoulder has a convex shape proceeding from the neck.

27. The container according to claim 24, wherein the second shoulder has a concave shape proceeding from the neck and runs with a convex shape into the casing.

28. The container according to claim 16, wherein the neck is blow molded together with the container.

29. The container according to claim 16, wherein the container is produced from HDPE, wherein the proportion of recycled HDPE is between 10 and 100% by weight.

30. The combination of a container according to claim 16, and a screw cap having an internal thread, which screw cap can be attached to the neck having an external thread, can be unscrewed therefrom, and has formed on its inner side a sealing element which, in the attached state, projects into the opening.
